(19) United States
(12) Patent Application Publication
(10) Pub. No.: US 2014/0286527 A1
(43) Pub. Date: Sep. 25, 2014

(54) SYSTEMS AND METHODS FOR ACCELERATED FACE DETECTION

(71) Applicant: QUALCOMM Incorporated, San Diego, CA (US)

(72) Inventors: Ashwath Harthattu, San Diego, CA (US); Yingyong Qi, San Diego, CA (US)

(73) Assignee: QUALCOMM Incorporated, San Diego, CA (US)

(21) Appl. No.: 14/054,362

(22) Filed: Oct. 15, 2013

Related U.S. Application Data
(60) Provisional application No. 61/803,729, filed on Mar. 20, 2013.

(51) Int. Cl. G06K 9/00

(52) U.S. Cl. CPC G06K 9/00228
USPC 382/103

(57) ABSTRACT

A method for face detection is disclosed. The method includes evaluating a scanning window using a first weak classifier in a first stage classifier. The method also includes evaluating the scanning window using a second weak classifier in the first stage classifier based on the evaluation using the first weak classifier.

### TECHNICAL FIELD

This application is related to and claims priority from U.S. Provisional Patent Application Ser. No. 61/803,729, filed Mar. 20, 2013, for “ACCELERATED FACE DETECTION.”

### TECHNICAL FIELD

The present disclosure relates generally to electronic devices. More specifically, the present disclosure relates to accelerated face detection.

### BACKGROUND

In the last several decades, the use of electronic devices has become more common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or with higher quality are often sought after.

Some electronic devices (e.g., cameras, video camcorders, digital cameras, cellular phones, smart phones, computers, televisions, etc.) capture or utilize images. For example, a digital camera may capture a digital image.

New and/or improved features of electronic devices are often sought for. As can be observed from this discussion, systems and methods that add new and/or improved features of electronic devices may be beneficial.

### BRIEF DESCRIPTION OF THE DRAWINGS

FIG. 1 is a block diagram illustrating an electronic device for accelerated face detection;

FIG. 2A is a block diagram illustrating an accelerated face detection module;

FIG. 2B illustrates some components within the system of FIG. 2A being implemented by a processor;

FIG. 3 is a flow diagram illustrating a method for performing accelerated face detection;

FIG. 4 is a flow diagram illustrating a method for performing adaptive step scanning window selection based on a confidence value;

FIG. 5 is a block diagram illustrating an early-termination cascade classifier;

FIG. 6A is a block diagram illustrating a stage classifier for examining a stage;

FIG. 6B illustrates some components within the system of FIG. 6A being implemented by a processor;

FIG. 7 is a flow diagram illustrating a method for evaluating a weak classifier;

FIG. 8 is a flow diagram illustrating a method for classifying a scanning window; and

FIG. 9 illustrates certain components that may be included within an electronic device/wireless device.

### SUMMARY

A method for face detection is described. The method includes evaluating a scanning window using a first weak classifier in a first stage classifier. The method also includes evaluating the scanning window using a second weak classifier in the first stage classifier based on the evaluation using the first weak classifier.

Evaluating the scanning window using the second weak classifier may include performing early termination of the first stage classifier by outputting a face decision for the first stage classifier without evaluating the second weak classifier when the evaluation using the first weak classifier is face. Evaluating the scanning window using the second weak classifier may also include performing early termination of the first stage classifier by outputting a non-face decision for the first stage classifier without evaluating the second weak classifier when the evaluation using the first weak classifier is non-face. Evaluating the scanning window using the second weak classifier may also include evaluating the scanning window using the second weak classifier when the evaluation using the first weak classifier is inconclusive.

The method may also include evaluating the scanning window using a third weak classifier in the first stage classifier based on the evaluation using the first weak classifier and the evaluation using the second weak classifier. Evaluating the scanning window using the third weak classifier may include performing early termination of the first stage classifier by outputting a face decision for the first stage classifier without evaluating the third weak classifier when a combination of the evaluation using the first weak classifier and the second weak classifier is face. Evaluating the scanning window using the third weak classifier may also include performing early termination of the first stage classifier by outputting a non-face decision for the first stage classifier without evaluating the third weak classifier when a combination of the evaluation using the first weak classifier and the second weak classifier is non-face. Evaluating the scanning window using the third weak classifier may also include evaluating the scanning window using the third weak classifier when the evaluation using the first weak classifier and the second weak classifier is inconclusive.

Evaluating the scanning window using the first weak classifier may include traversing a node tree of weak classifier features. A feature may be evaluated at a first level of the node tree to determine a next node on a next level of the node tree to evaluate. The weak classifiers may be local binary pattern (LBP) features. The LBP features may be evaluated using a lookup table with the LBP features as indices. Each pixel in the scanning window may be associated with a LBP that includes eight bits. Each bit may indicate an intensity of the pixel relative to one of eight neighboring pixels.

The stage classifiers may be evaluated using at least one ternary decision. Evaluating the scanning window using the first weak classifier may include obtaining a ternary decision of the first weak classifier. Evaluating the scanning window using the second weak classifier may be based on the result of the ternary decision of the first weak classifier.

Evaluating the scanning window using the second weak classifier may include obtaining a cumulative score of the first weak classifier and the second weak classifier. The cumulative score of the first weak classifier and the second weak classifier may be compared to a cumulative face threshold value and a cumulative non-face threshold value for the first weak classifier and the second weak classifier. Each weak classifier in the first stage classifier may include a cumulative face threshold value and a cumulative non-face threshold value loaded from memory. Evaluating the scanning window using the second weak classifier may include performing early termination of the first stage classifier if the cumulative score of the first weak classifier and the second weak classifier is face or non-face. Evaluating the scanning window using the second weak classifier may include obtaining a cumulative score of the first weak classifier, the second weak classifier and the third weak classifier if the cumulative score of the first weak classifier and the second weak classifier is inconclusive.

The method may also include selecting the scanning window using a first step size. The method may also include receiving a first confidence value indicating a likelihood that the scanning window includes at least a portion of a face. The method may also include determining a second step size based on the first confidence value. The first confidence value may be based on evaluating the scanning window using a first weak classifier. The first step size and the second step size may each include a number of pixels to skip in an x direction, a number of pixels to skip in a y direction or both. The method may also include selecting a second scanning window based on the second step size. The method may also include determining whether the second scanning window includes at least a portion of a face. The second step size may be further based on the first step size.

Determining a second step size may include assigning one or more first values to the second step size when the first confidence value indicates that the first scanning window likely includes at least a portion of a face. Determining the second step size may also include assigning one or more second values to the second step size when the first confidence value indicates that the first scanning window likely does not include at least a portion of a face. The first values may be less than the second values.

An apparatus for face detection is also described. The apparatus includes a means for evaluating a scanning window using a first weak classifier in a first stage classifier. The apparatus also includes a means for evaluating the scanning window using a second weak classifier in the first stage classifier based on the evaluation using the first weak classifier.

A computer-program product for face detection is also described. The computer-program product includes a non-transitory computer-readable medium having instructions thereon. The instructions include code for causing an electronic device to evaluate a scanning window using a first weak classifier in a first stage classifier. The instructions also include code for causing the electronic device to evaluate the scanning window using a second weak classifier in the first stage classifier based on the evaluation using the first weak classifier.

An apparatus for face detection is also described. The apparatus includes a processor and memory in electronic communication with the processor. The apparatus also includes instructions stored in memory. The instructions are executable to evaluate a scanning window using a first weak classifier in a first stage classifier. The instructions are also executable to evaluate the scanning window using a second weak classifier in the first stage classifier based on the evaluation using the first weak classifier.

### DETAILED DESCRIPTION

Performing frontal face detection may require a substantial amount of processing power. Existing techniques for performing face detection may rely upon robust processing power of a personal computer (PC) or other electronic device. Some methods of performing face detection may be less reliable on a mobile device or require more processing power than is generally available to various electronic devices (e.g., mobile devices, wireless devices, etc.). As a result, accurate or real-time face detection may be difficult or impossible to achieve on less powerful electronic devices using existing methods. Therefore, it may be advantageous to accelerate face detection to enable various electronic devices to perform face detection more efficiently.

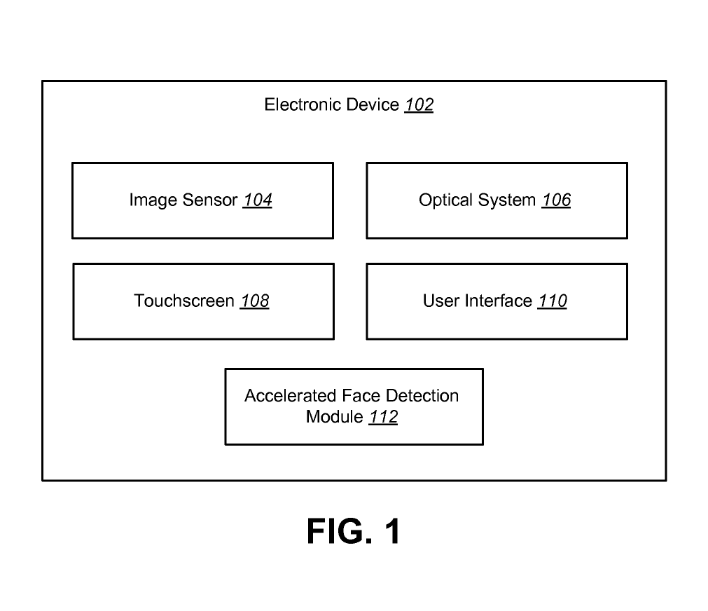

FIG. 1 is a block diagram illustrating an electronic device 102 for accelerated face detection. The electronic device 102 may also be referred to as a wireless communication device, a mobile device, mobile station, subscriber station, client, client station, user equipment (UE), remote station, access terminal, mobile terminal, terminal, user terminal, subscriber unit, etc. Examples of electronic devices 102 include laptops or desktop computers, cellular phones, smart phones, wireless modems, e-readers, tablet devices, gaming systems, etc. Some of these devices may operate in accordance with one or more industry standards.

An electronic device 102, such as a smartphone or tablet computer, may include a camera. The camera may include an image sensor 104 and an optical system 106 (e.g., lenses) that focuses images of objects that are located within the optical system's 106 field of view onto the image sensor 104. An electronic device 102 may also include a camera software application and a display screen. When the camera application is running, images of objects that are located within the optical system's 106 field of view may be recorded by the image sensor 104. The images that are being recorded by the image sensor 104 may be displayed on the display screen. These images may be displayed in rapid succession at a relatively high frame rate so that, at any given moment in time, the objects that are located within the optical system's 106 field of view are displayed on the display screen. Although the present systems and methods are described in terms of captured video frames, the techniques discussed herein may be used on any digital image. Therefore, the terms video frame and image (e.g., digital image) may be used interchangeably herein.

A user interface 110 of the camera application may permit a user to interact with an accelerated face detection module 112, e.g., using a touchscreen 108. The accelerated face detection module 112 may include an image scanner (e.g., adaptive step image scanner) and a cascade classifier (e.g., early-termination cascade classifier) that uses a sliding window approach to adaptively select a scanning window (e.g., within a video frame) to analyze. Specifically, the accelerated face detection module 112 may determine a scanning window for performing face detection (e.g., determining whether a face is present within the scanning window) on the scanning window. Determining a scanning window may include selecting a next scanning window relative to a previously selected scanning window. Selecting the next window may be based on a classifier confidence value obtained from performing face detection and classifying the previously selected scanning window. The classifier confidence value may provide a likelihood of whether a face is present in an analyzed scanning window. The classifier confidence value may be used to determine a location of a next scanning window. For example, if a previously selected scanning window is highly unlikely to include a face, it is unlikely that windows very close to the previous window would include a face. Therefore, the image scanner may select a window that is relatively far from the previous window (e.g., a large step size in the x direction, y direction or both). Conversely, if the previous window analyzed likely includes a face (or a portion of a face), nearby windows may also be likely to include at least a portion of the face. Therefore, the image scanner may select a window that is relatively close to the previous window (e.g., a small step size in the x direction, y direction or both). By using an adaptive step size instead of a fixed step size, the image scanner may reduce total processing for face detection with minimal loss of accuracy, i.e., the present systems and methods may use larger steps to avoid processing windows with a low likelihood of including a face or a portion of a face.

In some configurations, the accelerated face detection module 112 may determine a classifier confidence value as well as classifying a scanning window. As used herein, “classifying” a scanning window may include determining a status of a scanning window as “face” or “non-face.” For example, a scanning window classified as “face” may indicate a high confidence that a face is present within the scanning window. Conversely, a scanning window classified as “non-face” may indicate a low confidence that a face is present within the scanning window. Other classifications may exist to indicate varying levels of confidence regarding the presence of a face in a scanning window. In addition to classifying a scanning window, the cascade classifier may determine a specific confidence value to indicate a level of certainty as to whether a face is present in the scanning window.

The cascade classifier may further include multiple stage classifiers, each including multiple weak classifiers. Each stage within a stage classifier may be used to determine whether a face is present in the scanning window. Further, each stage and weak classifier may be used to decide whether to analyze (e.g., evaluate) subsequent stages and weak classifiers. In other words, for some scanning windows, less than all of the stages may be executed (i.e., evaluated) before a face/non-face decision for a scanning window is made. Further, some stages may be completed before each of the weak classifiers is examined within each stage. For example, in a stage with k weak classifiers, a first weak classifier may be examined to determine that the scanning window should be classified as a non-face or a face for a particular stage, and that none of the subsequent k−1 weak classifiers within the stage are needed to evaluate the scanning window. This may reduce processing in the cascade classifier (compared to executing every weak classifier in a stage before making a face or non-face stage decision). Classifying the scanning windows using stages and weak classifiers is described in additional detail below.

Further, it is noted that various decisions or classifications (e.g., face, non-face, inconclusive, etc.) may be made at various levels within a cascade classifier. In some configurations, “inconclusive” may be any decision or evaluation of a weak classifier that is neither face nor non-face. Therefore, as used herein, a window decision or decision regarding a scanning window may refer to a scanning window classification or an output of a cascade classifier. Further, a stage decision may refer to a stage classification or an output of a stage classifier. Further, a weak classifier decision (or combination of weak classifier decisions) may refer to one or more feature classifications or an output of a weak classifier. Other decisions may also be referred to herein.

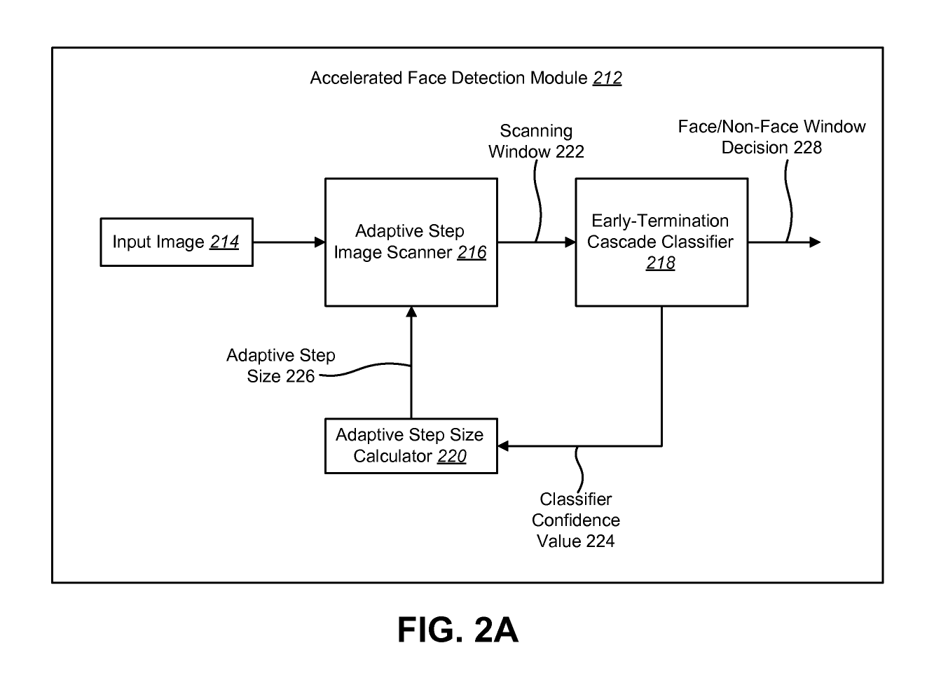

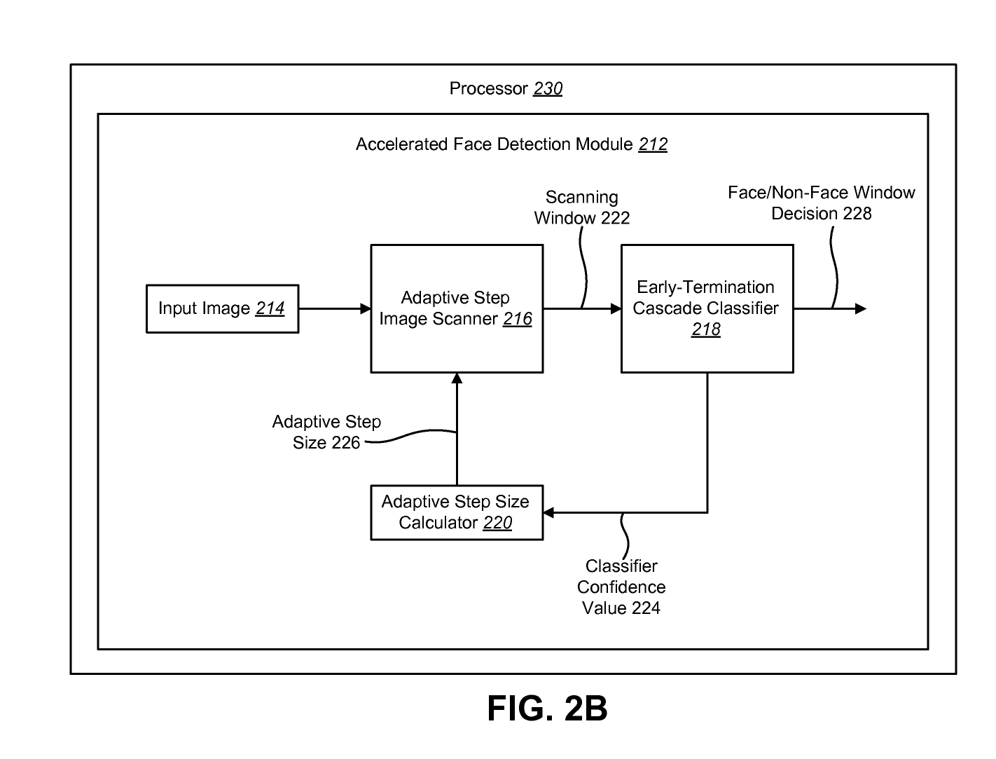

FIG. 2A is a block diagram illustrating an accelerated face detection module 212. The accelerated face detection module 212 may include an adaptive step image scanner 216, an early-termination cascade classifier 218 and an adaptive step size calculator 220. The adaptive step image scanner 216 may be coupled to the early-termination cascade classifier 218. Further, both the adaptive step image scanner 216 and the early-termination cascade classifier 218 may be coupled to the adaptive step size calculator 220. The accelerated face detection module 212 may further include additional modules not shown. For example, an image scaler and an image integrator (not shown) may be used to scale and integrate an original image or video frame and produce an input image 214 to be scanned and classified. Scaling and/or integrating an image may be performed by one or more modules within the accelerated face detection module 212 or by one or more modules coupled to the accelerated face detection module 212. Further, an electronic device 102 may include multiple accelerated face detection modules 212 that operate in parallel, each receiving an input image 214 that is scaled according to different scaling factors. Furthermore, the outputs of the multiple accelerated face detection modules 212 may be merged using a merging module (not shown) to obtain a face location.

An input image 214 may be received at the adaptive step image scanner 216. The input image 214 may be a scaled integral image produced from an original image received at an electronic device 102. For example, an original image may be scaled using a scaling component (not shown) and based on a scale factor to produce a scaled image. The scaled image may then be integrated using an integrating component (not shown) to produce a scaled integral image. The scaled integral image may be provided to the adaptive step image scanner 216 as the input image 214. Thus, the input image 214 may be a scaled integral image produced from a frame of a video or other digital image. The input image 214 may be a fixed size and resolution window that may be used to look for the existence of a face. Other sizes and resolutions of input images 214 may be used. In some configurations, the size and/or resolution of the input image 214 may be based on a minimum size of a face to be detected. In one example, an input image 214 may be scaled down to a specific size based on the scale factor and a scanning window 222 of a specific size (e.g., 24×24 pixels) may be selected for one or more scaled images. Thus, in a face detection model that is configured to detect faces of size 24×24 pixels, an image may be scaled in order to perform multi resolution face detection.

Further, the adaptive step image scanner 216 may select a scanning window 222 for the early-termination cascade classifier 218 to analyze, i.e., to determine a subset of pixels in the input image 214 in which the early-termination cascade classifier 218 looks for a face or a portion of a face. In one configuration, the first scanning window 222 selected may be a square (or other shape) of pixels having a width and height selected within points x=0, y=0 to x=24, y=24 of the input image 214. While performing such a scanning, based upon the sliding window technique over the image, a fixed step size (e.g., 1 or 2 pixels) may be used to obtain and analyze subsequent scanning windows 222. In one example, (stepSizeX, stepSizeY)=C, where C is a predetermined constant. In this example, the early-termination cascade classifier may produce a face/non-face window decision 228 for each of the scanning windows 222 selected using the adaptive step image scanner 216.

As used herein, a “step size” (e.g., adaptive step size 226) may include an indicator of a step in the x direction, y direction or both. For example, if the current stepSizeX is 5, the adaptive step image scanner 216 may skip 5 pixels from a previous scanning window 222 to select the current scanning window 222. Other step sizes (e.g., adaptive step sizes 226) may be used. In one configuration, the adaptive step image scanner 216 may select an adaptive step size 226 based on a correlation between neighboring windows.

In some configurations, the accelerated face detection module 212 may use an adaptive step size calculator 220 to determine an adaptive step size 226 based on a classifier confidence value 224. The adaptive step size 226 may also be based on a step size between previously selected scanning windows 222. For example, where there is a high correlation between neighboring windows (e.g., within an input image 214), the adaptive step size calculator 220 may determine an adaptive step size 226 for the subsequent scanning window 222 as a function of the current scanning window's classifier confidence value 224 and a previous step size. The adaptive step size calculator 220 may provide the adaptive step size 226 to the adaptive step image scanner 216. In one configuration, if a first scanning window 222 has a classifier confidence value 224 that indicates a very low likelihood of the first scanning window including some or all of a face (e.g., less than −0.8 on a scale from −1 to 1), the adaptive step size 226 used to select the second scanning window 222 may be large. In contrast, if a first scanning window 222 has a classifier confidence value 224 that indicates a very high likelihood of the first scanning window 222 including some or all of a face (e.g., higher than 0.8 on a scale from −1 to 1), the step size 226 used to select the second scanning window 222 may be relatively small.

Further, the adaptive step size 226 may be proportional from a minimum (e.g., 1 pixel) to a maximum (e.g., 5, 10, 12, 15 pixels). For example, a classifier confidence value 224 of −1 may translate to the maximum step size 226 and a classifier confidence value 224 of 1 may translate to a minimum step size 226 (e.g., 1 pixel). In other words, when the previous scanning window 222 likely includes a face or a portion of a face, smaller step sizes 226 may be used than when the previous scanning window is unlikely to include a face or a portion of a face. In one configuration, the step size 226 may range from a minimum of one pixel to a maximum of 4 times the current step size 226 (depending on the classifier confidence value 224). If the step size 226 falls below 1, the step size 226 may be defaulted to 1 pixel.

An example equation for determining adaptive step sizes 226 may be written according to Equation (1):

(stepSizeX_{—}n,stepSizeY_{—}n)=f{stepSizeX_{—}c,stepSizeY_{—}c,classifier(x,y)} (1)

where stepSizeX_n and stepSizeY_n are the x and y step sizes 226 for the next scanning window 222, stepSizeX_c and stepSizeY_c are the step size 226 of the current scanning window 222 and classifier(x,y) is the classifier confidence value 224 of the current scanning window 222. The classifier confidence value 224 may be a value between −1 and 1, where −1 indicates 100% confidence that a scanning window 222 does not include a face or a portion of a face and 1 indicates 100% confidence that a scanning window 222 includes a face or a portion of a face. Alternatively, other scales for the classifier confidence value 224 may be used, e.g., 0-100, 0-1, 0-255, etc.

Using an adaptive step size 226 may reduce the complexity of the sliding window technique by more than 50% with minimal loss of accuracy. Specifically, using an adaptive step size 226 may reduce selection of scanning windows 222 that are highly unlikely to include a face or a portion of a face, i.e., because they are very close to a previous scanning window 222 that was highly unlikely to include a face or a portion of a face.

The accelerated face detection module 212 may also include an early-termination cascade classifier 218 that receives scanning windows 222 from the adaptive step image scanner 216 and evaluates the scanning windows 222 in stages. For each scanning window 222, the early-termination cascade classifier 218 may output a face/non-face window decision 228 and a classifier confidence value 224. The early-termination cascade classifier 218 may include N stages, each with M weak classifiers. Rather than evaluating a scanning window 222 by executing each weak classifier in a stage and cumulating a score of all the weak classifiers for each stage, the early-termination cascade classifier 218 may determine, after evaluating each weak classifier, whether subsequent weak classifiers should be evaluated. For example, if evaluating a first weak classifier results in a high weak classification score (e.g., corresponding to a higher probability that a face is present in the scanning window 222), the remaining weak classifiers within a stage may not be evaluated. In other words, the early-termination cascade classifier 218 may terminate evaluation of subsequent weak classifiers within a stage prior to evaluating all M weak classifiers. Alternatively, if evaluation of a first weak classifier results in a low weak classification score (e.g., corresponding to a lower probability that a face is included in the scanning window 222), the remaining weak classifiers may not be executed for the stage. Further, the early-termination cascade classifier 218 may make a face/non-face stage decision at any weak classifier for a particular stage. The face/non-face stage decision may be based on the execution of a single weak classifier or a cumulative score based on the evaluation of multiple weak classifiers in a stage.

In some configurations, the early-termination cascade classifier 218 will not always terminate early. For example, the early-termination cascade classifier 218 may execute each weak classifier in a stage under various circumstances. For example, where execution of a weak classifier produces an inconclusive result (e.g., neither a face nor a non-face stage decision), a next weak classifier within a stage may be executed. If, while executing each of the weak classifiers, a face or non-face stage decision is made, the stage may output a face or non-face stage decision and the early-termination cascade classifier 218 may evaluate a next stage. By determining a face or non-face stage decision after every weak classifier in a stage, processing may be reduced overall without diminishing accuracy. Therefore, by using adaptive step sizes 226 (instead of fixed step sizes) and allowing for early termination within stages of the early termination cascade classifier 218 (instead of evaluating all weak classifiers within each stage), the accelerated face detection module 212 may reduce processing and enable real time face detection on electronic devices 102 with limited resources.

FIG. 2B illustrates some components within the system of FIG. 2A being implemented by a processor 230. As shown in FIG. 2A, the accelerated face detection module 212 may be implemented by a processor 230. Different processors may be used to implement different components (e.g., one processor may implement the adaptive step image scanner 216, another processor may be used to implement the early-termination cascade classifier 218 and yet another processor may be used to implement the adaptive step size calculator 220).

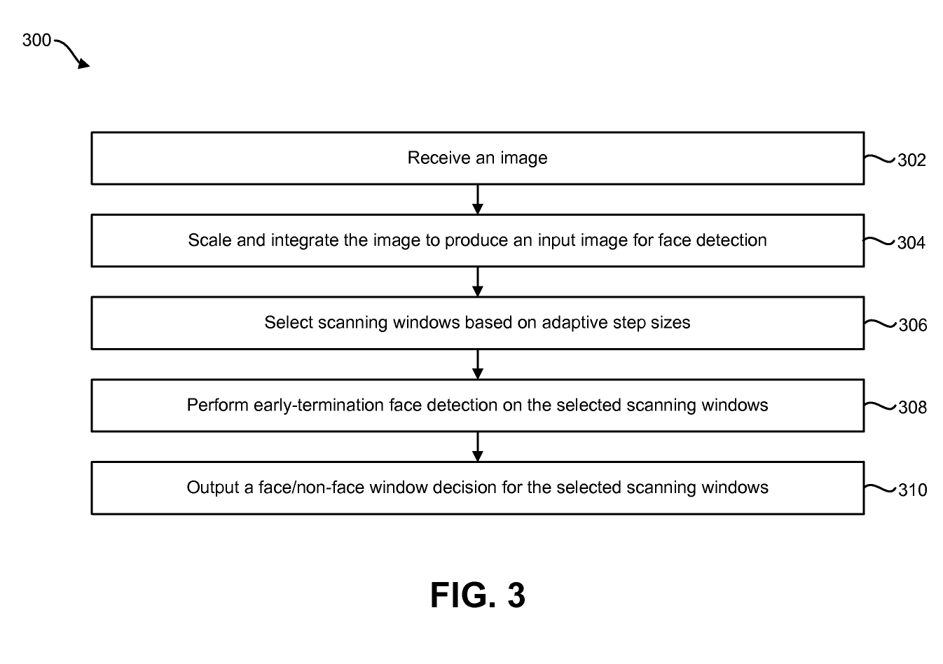

FIG. 3 is a flow diagram illustrating a method 300 for performing accelerated face detection. The method 300 may be performed by an electronic device 102. The method 300 may also be performed by an accelerated face detection module 112 in the electronic device 102. The accelerated face detection module 112 may receive 302 an image (e.g., from an image buffer). The image may be an image or video frame received by the electronic device (e.g., using a camera). The electronic device 102 may scale and integrate 304 the image to produce an input image 214 for face detection. Scaling the image may include scaling the received image according to a scaling factor to produce a reduced version of the received image (e.g., a 24×24 pixel representation of the received image). The scaling may be based on a minimum size of the face that should be detected. The electronic device 102 may also integrate the image (e.g., the scaled image) by obtaining an integral (e.g., a double integral) of the scaled image to produce an input image 214 for scanning and face detection. For example, integrating the image may include performing a double integral of the pixels (e.g., 24×24 pixels) of the scaled image to know what the area of the pixels are, and representing sections of pixels with average values. In one example, an integrated image may be broken up in four corners and an average intensity of each corner may be determined to be representative of each pixel block. The scaled and integrated image may enable examining only a subset of pixels in order to access features of an input image 214 without scanning a received image having a higher resolution.

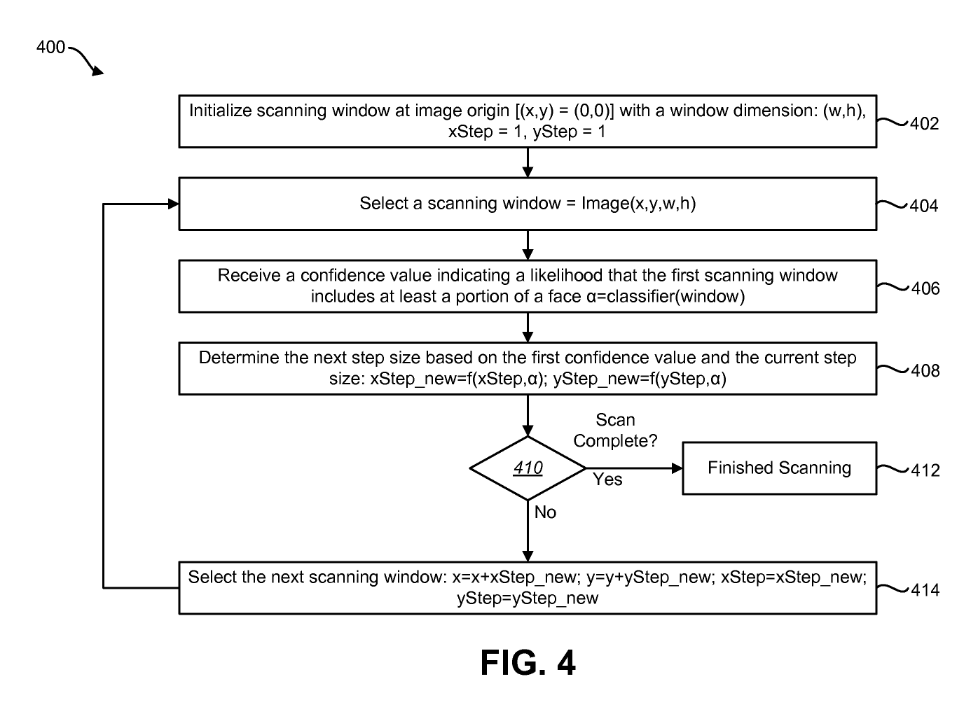

The electronic device 102 may also select 306 scanning windows 222 based on adaptive step sizes 226. Selecting 306 a scanning window 222 may include selecting a portion (e.g., scanning window 222) of the input image 214 for determining the presence of a face. The scanning window 222 may be a selection of a group of pixels having various shapes and sizes. A location of the scanning window 222 may be anywhere on the input image 214. For example, a previous scanning window 222 may be located at a position of x,y=0,0 on the input image 214. A location of a next scanning window 222 may be based on an adaptive step size 226. As discussed above, the adaptive step size 226 may be based on a classifier confidence value 224 and a previous step size. Therefore, selecting 306 a scanning window 222 may be based on the classification result of previously selected scanning windows 222. Selecting 306 scanning windows 222 will be described in additional detail below in connection with FIG. 4.

The electronic device 102 may also perform 308 early-termination face detection on the selected scanning windows 222 (e.g., evaluating scanning windows 222). Performing 308 early-termination face detection may include executing multiple classification stages, as well as executing weak classifiers within each stage. In some configurations, classification stages may be executed without examining each of the weak classifiers within each stage. For example, if a weak classifier indicates with a high enough confidence that a particular stage may be classified as a face or non-face, a stage classifier may output the face or non-face stage decision without executing additional weak classifiers. Additionally, the weak classifiers may determine a face or non-face classification for a stage based on a cumulative weak classifier score of a subset of the weak classifiers within a stage.

The electronic device 102 may output 310 a face/non-face window decision 228 for the selected scanning windows 222. The face/non-face window decision 228 may be an indication of whether a selected scanning window 222 includes a face or a portion of a face. A non-face window decision may be based on execution of some or all of the stages within the early-termination cascade classifier 218. A face window decision may be based on execution of all of the stages within the early-termination cascade classifier 218. In addition to a face or non-face decision for the scanning window 222, the early-termination cascade classifier 218 may output a confidence value 224 corresponding to a level of confidence that a face is present or not present in a selected scanning window 222. The accelerated face detection module 212 may perform this process on one or multiple input images 214 as well as multiple scanning windows 222 within each input image 214.

FIG. 4 is a flow diagram illustrating a method 400 for performing adaptive step scanning window selection based on a confidence value 224. The method 400 may be performed by an accelerated face detection module 212 in an electronic device 102. The accelerated face detection module 212 may initialize 402 a scanning window 222 at image origin: (x,y)=(0,0) with a window dimension of (w,h) and xStep=1, yStep=1. The accelerated face detection module 212 may also select 404 a scanning window 222 defined by Image(x,y,w,h). The scanning window 222 may be a portion of an input image 214, e.g., an integral image determined from a frame of a video. The accelerated face detection module 212 may also receive 406 a confidence value (α=classifier(window)) 224 indicating a likelihood that the scanning window 222 comprises at least a portion of a face, e.g., an early-termination cascade classifier 218 may feedback a classifier confidence value (α) 224 for the first scanning window 222 to an adaptive step size calculator 220. The accelerated face detection module 212 may also determine 408 a next step size 226 based on the confidence value 224 and the first (e.g., current) step size. This may include assigning a larger second step size 226 when the first confidence value 224 indicates a low probability (e.g., less than −0.5, −0.6, −0.7, −0.8, −0.9, etc. on a scale from −1 to 1) that the first scanning window 222 includes a face or a portion of a face. Conversely, a smaller second step size 226 may be assigned when the first confidence value 224 indicates a high probability (e.g., higher than 0.5, 0.6, 0.7, 0.8, 0.9, etc. on a scale from −1 to 1) that the first scanning window 222 includes a face or a portion of a face. Alternatively, the next step size 226 may be based on the confidence value 224 alone. The accelerated face detection module 212 may determine 410 if the scan is complete. If the scan is complete, the scanning is finished 412. If the scanning is not complete, the accelerated face detection module 212 may also select 414 a next scanning window 222 based on the second step size: x=x+xStep_new; y=y+yStep_new; xStep=xStep_new; yStep=yStep_new.

Therefore, the next step size 226 may or may not be based on the current step size and may be calculated based on the confidence value 224 itself. For the first scanning window 222, when there is no classifier confidence value feedback, step size 226 may be defaulted (e.g., to one pixel) and only subsequent step sizes 226 will be evaluated.

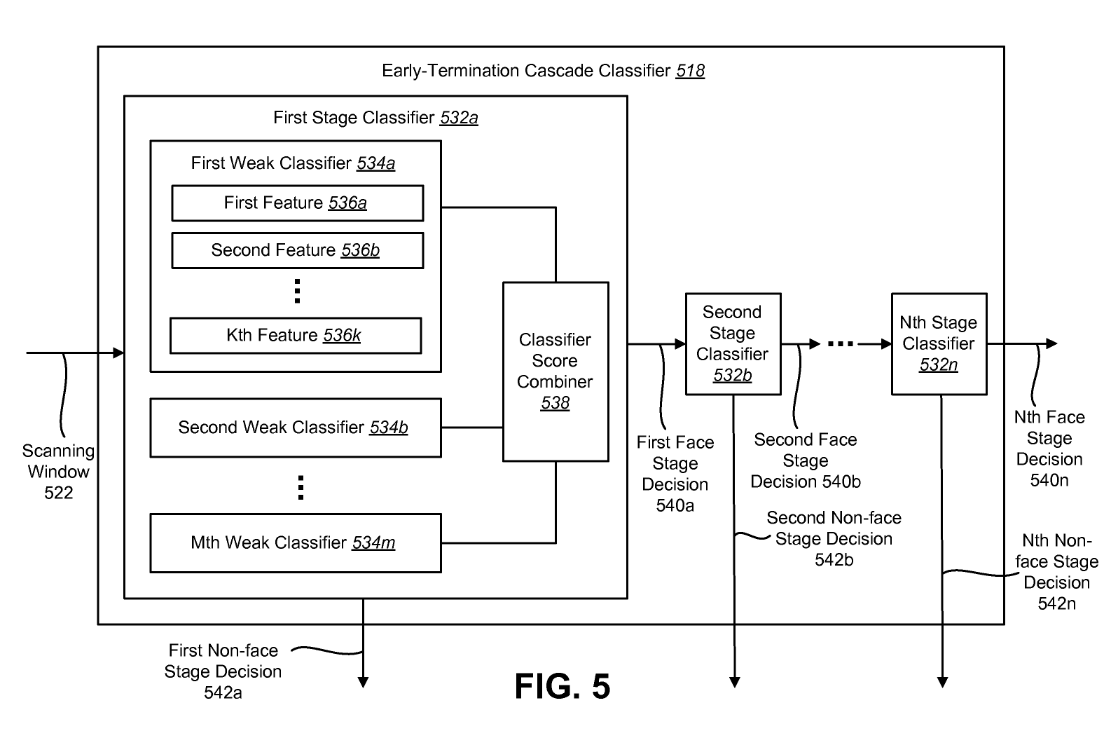

FIG. 5 is a block diagram of an early-termination cascade classifier 518. The classifier 518 may include N (n=1, 2, . . . N) stage classifiers 532a-n. For example, the early-termination cascade classifier 518 may include a first stage classifier 532a, a second stage classifier 532b and any number of additional stage classifiers 532 based on a number of stages determined during a training phase. Each stage classifier 532 may include multiple weak classifiers 534a-m (e.g., M weak classifiers), with each weak classifier 534 including multiple features 536a-k (e.g., K features). Further, each stage classifier 532 may include a classifier score combiner 538 for obtaining a combined weak classifier score based on the weak classifiers 534 that have been executed. The combined weak classifier score may be used to determine a face or non-face stage decision 540, 542. The classifier score combiner 538 may also be used to determine a face, non-face, or inconclusive weak classifier decision for the weak classifiers 534 that have been executed within a stage.

In one configuration, a first stage classifier 532a may receive a scanning window 522 (e.g., from the adaptive step image scanner 216). The first stage classifier 532a may examine a first stage to determine a first face stage decision 540a or a first non-face stage decision 542a for the first stage. The first stage decision may be based on an analysis of multiple weak classifiers 534 and features 536 within each weak classifier 534. Thus, the first stage classifier 532a may receive a scanning window 522 and determine a first stage decision (e.g., face or non-face) 540a, 542a for the scanning window 522 and output either a first face stage decision 540a or a first stage non-face decision 542a. Upon completion of some or all of the stages, the early-termination cascade classifier 518 may output a confidence value for the scanning window 522. The confidence value may be used to determine a face or non-face window decision. In some configurations, the confidence value may give a level of certainty associated with the face or non-face window decision, which may be provided as an output of the early-termination cascade classifier 518. As described above, this confidence value may be used in selecting a subsequent scanning window 522 or a step size between scanning windows 522. Further, the face/non-face window decision 228 may be based on a comparison of the confidence value to a specific threshold.

In determining a face or non-face window decision, each stage classifier 532 may be executed to output a stage decision (e.g., a face or a non-face stage decision) for each individual stage. If a stage decision is determined to be non-face, the early-termination cascade classifier 518 may terminate further execution of the stages and output a non-face window decision for the selected scanning window 522 (i.e., without examining subsequent stages). Conversely, if a stage decision is determined to be face, a next stage may be examined using a subsequent stage classifier 532. Upon examination of each stage, and determining a face decision 540a-n at the output of each stage classifier 532a-n, the early-termination cascade classifier 518 may output a face window decision for the selected scanning window. This, an Nth face stage decision 540n may be the equivalent of a face window decision 228 for the early-termination cascade classifier 218. In some configurations, if any of the stage classifiers 532 outputs a non-face stage decision 542, then the early-termination cascade classifier 518 may cease examining subsequent stages, and output a non-face window decision for the scanning window 522. Thus, any of the non-face stage decisions 542a-n may be equivalent to a non-face window decision of the early-termination cascade classifier 218. In this example, the early-termination cascade classifier 518 may only output a face window decision for a scanning window 522 upon examining each of the stages with each stage classifier 532a-n outputting a face stage decision 540a-n.

In one configuration, the classifier confidence value may be determined based on which stage in the early-termination cascade classifier the current scanning window 522 has exited out (e.g., if a scanning window 522 exited early in the cascade stage, it has lower probability of being a face than a scanning window 522 that exited after executing all stage classifiers 532). For example, in a configuration with 12 stage classifiers 532, a scanning window 522 that exits after stage 1 may have a lower probability (e.g., 1/12) than a scanning window 522 that exits after stage 7 (e.g., 7/12). Such a probability may be used as or converted to a classifier confidence value. For example, if the probability is 1/12, the next step size may be 3× the current step size. Additionally, if the probability is 6/12, the next step size may be equal to the current step size. Further, if the probability is 10/12, the next step size may be half the current step size. Other scales may be used when determining subsequent step sizes. Moreover, the stage number where the scanning windows 522 exit may also be combined with a deviation measure in making further step size adaptations (e.g., how different is a weak classifier or stage score from the stage threshold).

Each stage classifier 532 may also include M (m=1, 2, . . . M) weak classifiers 534a-m. For example, a first stage classifier 532a may include a first weak classifier 534a, a second weak classifier 534b and any number of additional weak classifiers 534 (e.g., M classifiers) determined during a training phase. Weak classifiers 534 may correspond to a simple characteristic or feature of a scanning window 522 that provides an indication of the presence or absence of a face within the scanning window 522. In some configurations, a first weak classifier 534a is executed to determine a first weak classifier score. A weak classifier score may be a numerical value indicating a level of confidence that a stage will produce a stage decision of face or non-face (e.g., corresponding to a likelihood that a face is present or not present within a scanning window). In some configurations, the weak classifier score is a number between −1 and 1. Alternatively, the weak classifier score may be a number between 0 and 255, or other range of numbers depending on possible outcomes of the weak classifier 534. The first weak classifier 534a may also be examined to determine a first weak classifier decision. A weak classifier decision may be a face, non-face, or inconclusive decision. A weak classifier face decision may be based on a comparison with a face threshold. A weak classifier non-face decision may be based on a comparison with a non-face threshold. A weak classifier inconclusive decision may be based on both comparisons of the face and non-face thresholds (e.g., where a weak classifier decision is not a face or a non-face decision).

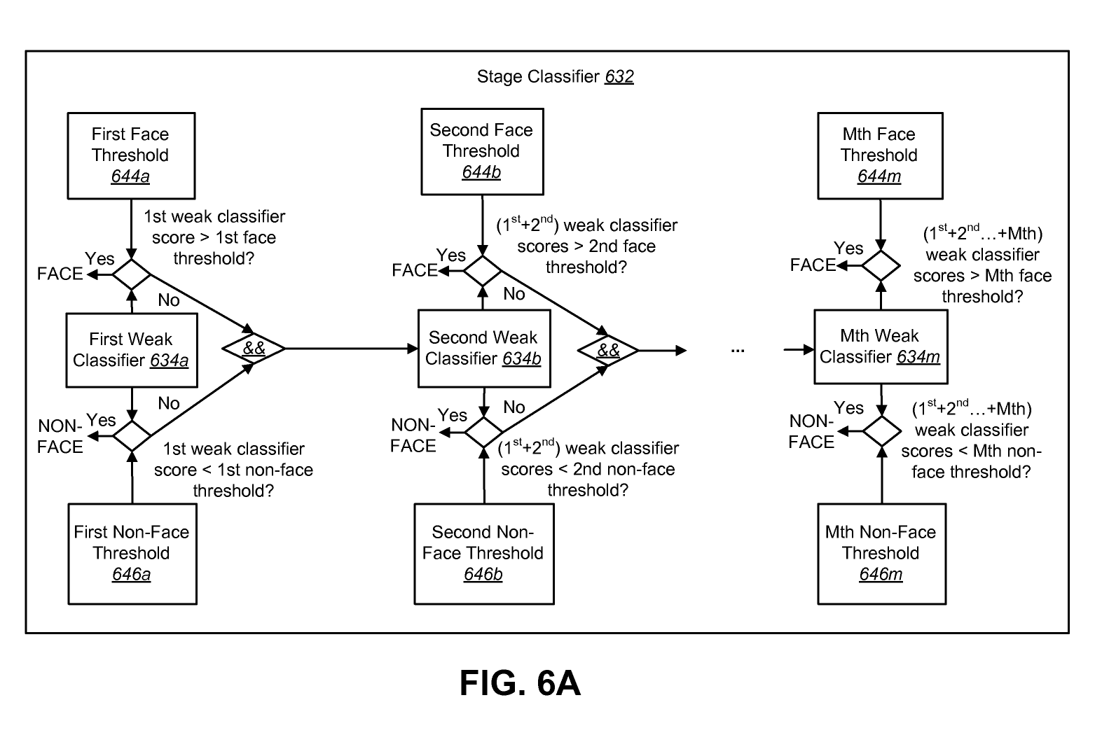

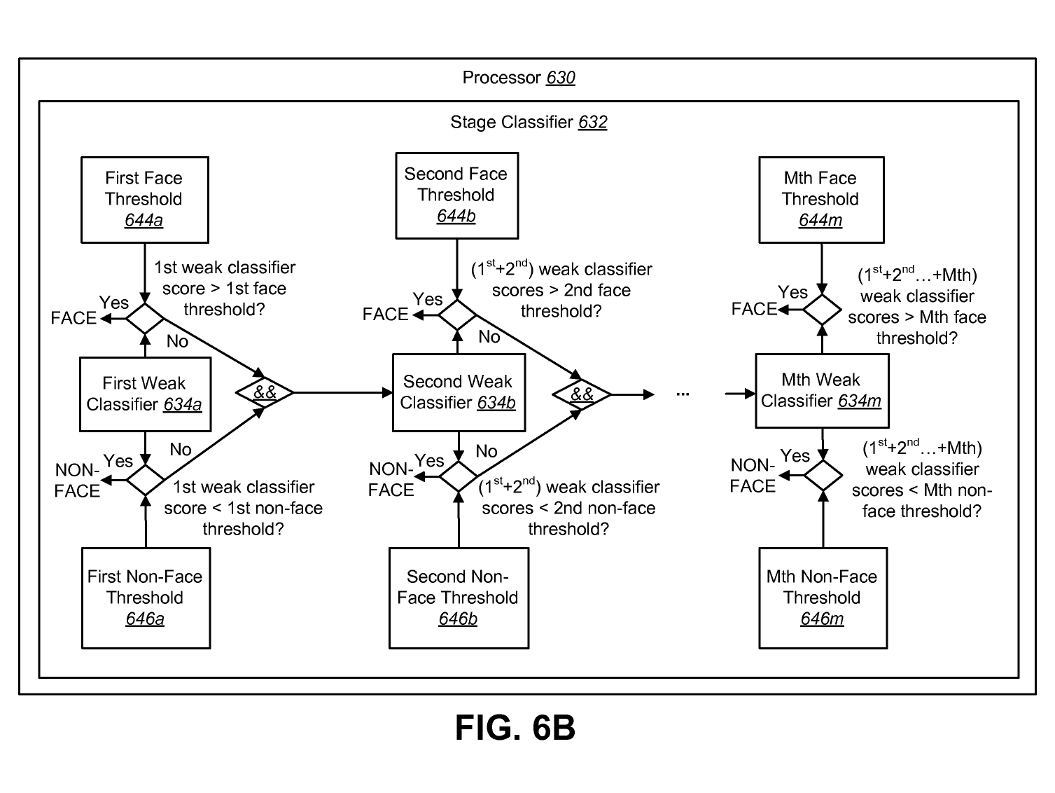

In one example, a first weak classifier 534a is executed to determine a first weak classifier decision and a first weak classifier score. If the first weak classifier decision is a face, the first stage classifier 532a may cease execution of the remaining weak classifiers 534, output a first face decision 540a and proceed onto execution of a second stage classifier 532b. Conversely, if the first weak classifier decision is a non-face, the first stage classifier 532a may cease execution of the remaining weak classifiers 534 and output a first non-face stage decision 542a. In this case, because the first stage classifier 532a outputs a non-face stage decision 542, the early-termination cascade classifier 518 may output a non-face window decision for the scanning window 522 and a confidence value. In another configuration, where the first weak classifier 534a outputs an inconclusive weak classifier decision, the first weak classifier 534a may provide a first weak classifier score to the classifier score combiner 538 and proceed to examine a second weak classifier 534b. In this case, evaluating the second weak classifier score may include determining a second weak classifier score and providing the second weak classifier score to the classifier score combiner 538. The classifier score combiner 538 may determine a weak classifier decision for the second weak classifier 534b based on the combined outputs of the first weak classifier 534a and the second weak classifier 534b. This combined result may be used to determine a face, non-face, or inconclusive weak classifier decision for the second weak classifier 534b. Similar to examination of the first weak classifier 534a, if the second weak classifier decision is a face or non-face decision, the first stage classifier 532a may cease execution of subsequent weak classifiers 534 and output a face or non-face stage decision. Alternatively, if the second weak classifier decision is inconclusive, subsequent weak classifiers 534 within the first stage classifier 532a may be executed. This process of subsequent analysis of weak classifiers 534 is explained in additional detail below in connection with FIG. 6A.

Moreover, each weak classifier 534 may include multiple features (e.g., K features) 536a-k that may be examined to determine a face, non-face, or inconclusive decision for each weak classifier 534. In some configurations, the features 536 may be local binary pattern (LBP) features. An LBP feature may be a byte associated with a pixel that indicates intensity of the pixel relative to its 8 neighbor pixels. Specifically, if the pixel of interest has a higher intensity than a first neighboring pixel, a ‘0’ bit may be added to the LBP feature. Conversely, if the pixel of interest has a lower intensity than a second neighboring pixel, a ‘1’ bit may be added to the LBP feature for the pixel of interest. These LBP features may be learned during training prior to face detection, e.g., based on Adaboost or any other machine learning technique. In this way, each pixel in a scanning window 522 may be associated with an 8-bit LBP feature. Therefore, in an example of a 24×24 pixel face, the face may have close to 10,000 LBP features. Alternatively, the weak classifier features 536 may include other types of features (e.g., Haar features). Moreover, by using an integration approach when examining features, the sum of the intensity of an image patch can be calculated using only 4 memory access. For example, to find the average intensity of an image in a 3×3 patch, a traditional approach may include accessing all 9 pixels and calculating a sum. Using an integral approach, an image may be scaled and integrated such that only 4 memory access is required to compute a sum of the intensity of an image patch. Thus, performing face detection using an integral approach may use less processing on an electronic device 102.

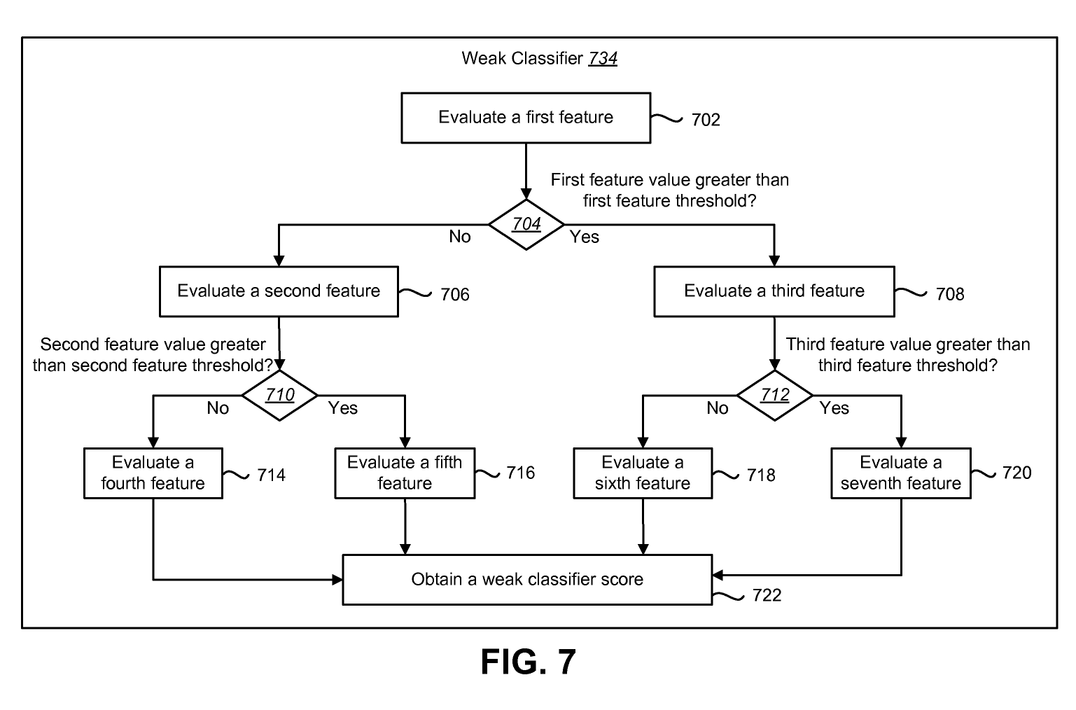

In examining the features 536 within a weak classifier 534, some or all of the features 536 may be analyzed to obtain a weak classifier decision and a weak classifier score. In one configuration, only a portion of the K features 536a-k are analyzed in examining a weak classifier 534. Further, examining a weak classifier 534 based on the K features 536a-k may include traversing a node tree of the weak classifier features 536a-k. Traversing a node tree may include evaluating a first level of the node tree to determine a next node on a next level of the node tree to evaluate. Thus, a weak classifier 534 may be examined by traversing a node tree and only examining one feature 536 per level of the node tree. Examining the features 536 of a weak classifier 534 is described in additional detail below in connection with FIG. 7.

FIG. 6A is a block diagram illustrating a stage classifier 632 for examining a stage. The stage may include M weak classifiers 634a-m and two thresholds 644, 646 per weak classifier 634, i.e., a total of 2M thresholds. The terms “stage” and “stage classifier” may be used interchangeably herein.

In a Viola Jones (VJ) framework for classification, each stage classifier may include a number of weak classifiers and a weak classifier score that is accumulated at the end of every corresponding stage. This is followed by a comparison of these accumulated weak classifier confidences against the stage threshold to make the decision as to whether a current window decision is a face or a non-face. Note that the stage threshold and range of weak classifier confidences are learned during the training process. In this framework, if a classifier decides the present window is a face, then the window is presented to the subsequent stage. As a result, before a scanning window is labeled as face, each stage classifier may output a face stage decision. On the other hand, as soon as a scanning window is labeled as a non-face (at any stage), the early-termination cascade classifier can cease executing subsequent stages and output a non-face decision for the scanning window. In this framework where each weak classifier is accumulated before producing a face or non-face decision for a stage, a decision of face or non-face for each stage may be expressed according to Equations (2) and (3):

sum(weakClassifier1+weakClassifier2+ . . . )>stageThreshold=>Face (2)

sum(weakClassifier1+weakClassifier2+ . . . )<stageThreshold=>Not Face (3)

In another configuration, each stage classifier 632 may include a number of weak classifiers 634 and a weak classifier score may be obtained upon examination of each subsequent weak classifier 634 (e.g., without examining every weak classifier 634 within a stage). In examining a weak classifier score, each of the previously examined weak classifiers 634 is accumulated (e.g., using a classifier score combiner 538) to determine a combined weak classifier score for each of the classifiers 634 that have been examined. This combined score is compared against a face threshold 644 and a non-face threshold 646 for each weak classifier 634 to make a decision as to whether the stage classifier 632 will output a stage decision of face or non-face. Also note that the various thresholds 644, 646 and range of weak classifier confidence are learned during the training phase. Thus, since the stage threshold and range of weak classifier confidence values are learned during the training phase, the stage classifier 632 may use some statistical analysis of this data to make the face/non-face stage decision upon execution of each individual weak classifier 634 (rather than at the end of the stage). Hence, execution of subsequent weak classifiers 634 may be skipped. Since the proposed weak classifier confidences (e.g., scores) are real values, the possible max and min value of each of the weak classifiers 634 may be estimated from the trained classifier model. Based on these estimated values, thresholds for the weak classifier level early termination, rather than stage level termination, cascade may be defined.

In one example, a weak classifier decision may be defined according to Equation (4):

weakClassifier1>weakClassifierThreshold1_face=>Face (4)

where weakClassifierThreshold1_face (first face threshold 644a) is defined according to Equation (5):

weakClassifierThreshold1_face={stageThreshold−sum(min(weakClassifier2)+min(weakClassifier3)+ . . . ))} (5)

where stageThreshold is the stage threshold learned during the training phase, weakClassifier2 is the score output by the second weak classifier 634b, weakClassifier3 is the score output by a third weak classifier, etc. Furthermore, a non-face weak classifier decision may be determined according to Equation (6):

weakClassifier1<weakClassifierThreshold1_notface=>not Face (6)

where weakClassifierThreshold1_notface (first non-face threshold 646a) is defined according to Equation (7):

weakClassifierThreshold1_notface={stageThreshold−sum(max(weakClassifier2)+max(weakClassifier3)+ . . . ))} (7)

Similarly, for the second weak classifier 634b, a face weak classifier decision may be defined according to Equation (8):

sum(weakClassifier1+weakClassifier2)>weakClassifierThreshold2_face=>Face (8)

where weakClassifierThreshold2_face (second face threshold 644b) is defined according to Equation (9):

weakClassifierThreshold2_face={stageThreshold−sum(min(weakClassifier3)+min(weakClassifier4)+ . . . ))} (9)

Furthermore, a non-face weak classifier decision may be determined according to Equation (10):

sum(weakClassifier1+weakClassifier2)<weakClassifierThreshold2_notface=>not Face (10)

where weakClassifierThreshold2_notface (second non-face threshold 646b) is defined according to Equation (11):

weakClassifierThreshold2_notface={stageThreshold−sum(max(weakClassifier3)+max(weakClassifier4)+ . . . ))} (11)

This procedure may be iterated for all the available weak classifiers 634a-m within a respective stage. The present systems and methods may make ternary decisions within each stage rather than the binary decision at the end of the stage. In contrast, decision-making employed in the VJ framework described above may make binary decisions for each stage only after examination of each weak classifier 634. In the VJ framework, the stage classifier 632 only makes a binary decision at the end of a particular stage and no ternary decision is acceptable. According to the present systems and methods, if the stage classifiers 632 would not be able to make a stage decision in the earlier weak classifiers 634 with their associated face and non-face thresholds 644, 646 the last weak classifier 634m will be treated in the same way as the traditional cascade framework. This means that if none of the earlier dual threshold-based early-cascade termination hypotheses are satisfied, in the final weak classifier 634m, the summed weak classifier responses are compared against the stage threshold to make a binary decision. In other words, as illustrated in FIG. 6A, the Mth face threshold 644m and the Mth non-face threshold 646m may be combined as a single stage threshold (or have identical threshold values) such that the output of the mth weak classifier 634m is either a face or a non-face stage decision. As a consequence, the thresholds may be defined according to Equations (12)-(13):

weakClassifierThresholdM_face=stageThreshold (12)

weakClassifierThresholdM_notface=stageThreshold (13)

where weakClassifierThresholdM_face and weakClassifierThresholdM_notface are the weak classifier threshold for the Mth (last) weak classifier 634m in a particular stage. Therefore, the weak classifier thresholds 644, 646 may be derived with the help of stage threshold and statistical analysis of the weak classifier's confidence. One advantage of such a mechanism is that a decision can be made prior to a stage threshold, at every weak classifier level, in order to decide whether subsequent weak classifiers 634 need to be evaluated to make a decision about the current scanning window 522. In other words, if neither decision for a particular weak classifier 634 in the stage classifier 632 is conclusive, the next weak classifier 634 may be evaluated. In one configuration, if none of the earlier weak classifier dual hypotheses are satisfied, then the sum of all the Mth weak classifiers 634a-m in the Nth stage classifier may be compared against the stage threshold at the end of the stage. In addition to the weak classifier-based threshold, the weak classifiers 634 may be rearranged in such a way that the probability of making the face or non-face decision will be faster.

One advantage of the present systems and methods is that it is a lossless acceleration technique, i.e., since the decision made at the weak classifier level would also be true if we had made that decision at the stage level as in classical VJ framework. In a typical evaluation process, this method may reduce the time of face detection almost 15% with no change in the detection accuracy.

FIG. 6B illustrates some components within the system of FIG. 6A being implemented by a processor 630. As shown in FIG. 6A, the stage classifier 632 may be implemented by a processor 630. Different processors may be used to implement different components (e.g., one processor may implement a first weak classifier 634a, another processor may be used to implement second weak classifier 634b and yet another processor may be used to implement one or more additional weak classifiers 634).

FIG. 7 is a flow diagram illustrating an exemplary weak classifier 734 (e.g., in a stage classifier 532 in an early-termination cascade classifier 518). Each weak classifier 734 may comprise a different node tree with a feature at each node in the tree. In one example, each node may be associated with a local binary pattern (LBP) feature. As described above, an LBP feature may be a byte associated with a pixel that indicates intensity of the pixel relative to its 8 neighbor pixels. Specifically, if the pixel of interest has a higher intensity than a first neighboring pixel, a ‘0’ bit may be added to the LBP feature. Conversely, if the pixel of interest has a lower intensity than a second neighboring pixel, a ‘1’ bit may be added to the LBP feature for the pixel of interest. These LBP features may be learned during training prior to face detection, e.g., based on Adaboost or any other machine learning technique. In this way, each pixel in a scanning window 522 may be associated with an 8-bit LBP feature. Therefore, in an example of a 24×24 pixel face, the face may have close to 10,000 LBP features.

The node features of the weak classifier 734 may be learned and assigned during the training process. Each weak classifier 734 in an early-termination cascade classifier 518 may be unique. Further, only a portion of the possible features may be assigned during the training process to be examined by a weak classifier 734. Determining which features are to be examined may include analyzing a combination of features or a collection of more important features that would best predict the presence or absence of a face in a scanning window 522. During face detection, the tree may be traversed using a pre-stored lookup table (LUT) (also from training) with the LBP features as indices. At each node, a feature may be evaluated, which indicates a next node to visit (and associated LBP feature to evaluate). The output of the weak classifier (e.g., a weak classifier score) may be a value between 0 and 255. Although shown with only three levels, the weak classifier 734 may include any suitable number of levels and nodes/features, e.g., three, four, five, six levels. This weak classifier score may then be scaled to a confidence value (e.g., between −1 and 1) and used to select an adaptive step size for an image scanner. This weak classifier score may also be used to determine a weak classifier decision of face, non-face, or inconclusive. The weak classifier(s) 734 may use, but are not limited to, binary stump (e.g., used in VJ framework), real valued decision tree, real valued LUT, logistic regression (Intel's SURF), etc.

In one example, the weak classifier 734 evaluates 702 a first feature. Evaluating the first feature may produce a first feature value. In one configuration, evaluating a feature may include defining a pixel pattern (e.g., during a training stage) and comparing regions of an input image or scanning window 522 to obtain a feature value. In one configuration, a feature may include multiple regions of pixels (e.g., a black region and a white region). A feature value may be calculated by subtracting values (e.g., pixel values) of a first region from values of a second region of a defined feature. Additional regions may be included within a feature. By performing various calculations on the feature regions (e.g., using a weak classifier 734), a feature value may be calculated for a particular feature. In this example, a first feature value may be calculated when evaluating a first feature.

The weak classifier 734 determines 704 whether a first feature value is greater than a first feature threshold. If the first feature value is not greater than a first feature threshold, the weak classifier 734 may evaluate 706 a second feature. The second feature may be evaluated using a similar method as the first feature. Conversely, if the first feature value is greater than a first feature threshold, the weak classifier 734 may evaluate 708 a third feature. Thus, for a second level, the weak classifier 734 may evaluate either a second feature or a third feature, and bypass one in lieu of the other. In a configuration where the second feature is evaluated, the weak classifier 734 may determine 710 whether a second feature value is greater than a second feature threshold. If not, the weak classifier 734 may evaluate 714 a fourth feature. If yes, the weak classifier 734 may evaluate 716 a fifth feature. In a configuration where the third feature is evaluated (rather than the second feature), the weak classifier 734 may determine 712 whether a third feature value is greater than a third feature threshold. If not, the weak classifier 734 may evaluate 718 a sixth feature. If yes, the weak classifier 734 may evaluate 720 a seventh feature. Thus, for a third level of the node tree, the weak classifier 734 may evaluate either a fourth feature, fifth feature, sixth feature or seventh feature. Upon evaluation of one feature per level, the weak classifier 734 may obtain 722 a weak classifier score. The weak classifier 734 score may be used to make a face, non-face, or inconclusive weak classifier decision or be used in calculating a classifier confidence value.

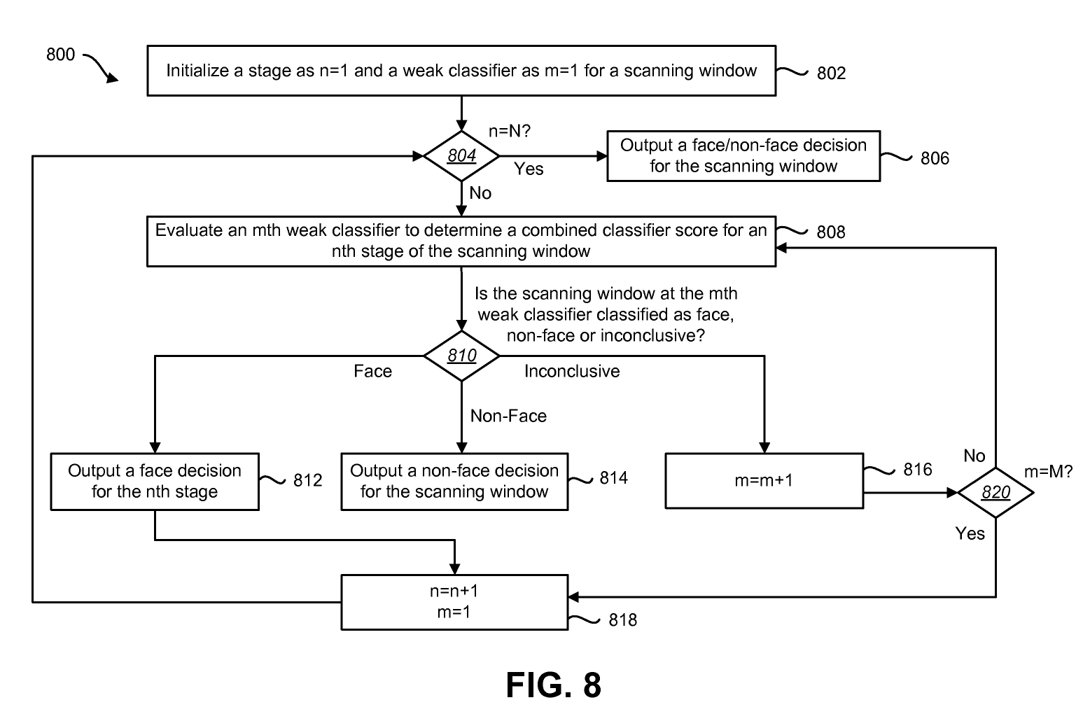

FIG. 8 is a flow diagram illustrating a method 800 for classifying a scanning window 222. The method 800 may be performed by an electronic device 102 (e.g., an early-termination cascade classifier 218). The early-termination cascade classifier 218 may initialize 802 a stage as n=1 and a weak classifier as m=1 for a scanning window 222. Further, N may equal the total number of stages and M may equal the total number of weak classifiers within a particular stage. It is noted that M may be a different value for different stages. The early-termination cascade classifier 218 may determine 804 whether n is equal to N. If n=N (i.e., all the stages have been traversed), the early-termination cascade classifier 218 may output 806 a face/non-face window decision 228 for the scanning window 222. If n is not equal to N (i.e., all the stages have not been traversed), the early-termination cascade classifier 218 may evaluate 808 an mth weak classifier to determine a combined classifier score for an nth stage of the scanning window 222.

The early-termination cascade classifier 218 may determine 810 if the scanning window 222 at the mth weak classifier is classified as face, non-face, or inconclusive (e.g., neither a face nor a non-face weak classifier decision). This weak classifier decision may be based on a combined score of each weak classifier already examined within a stage. This combined score may be compared to an upper threshold and a lower threshold in determining a face, non-face, or inconclusive weak classifier decision. If the combined classifier score is below a lower threshold (e.g., a non-face threshold), the early-termination cascade classifier 218 may determine that the scanning window 222 is classified as non-face. In this case, the early-termination cascade classifier 218 may output 814 a non-face decision for the scanning window 222. If the combined classifier score is over a higher threshold (e.g., a face threshold), the early-termination cascade classifier 218 may determine that the present stage of the scanning window 222 is classified as face. In this case, the early-termination cascade classifier 218 may output 812 a face stage decision for the nth stage. The early-termination cascade classifier 218 may then set 818 n=n+1, m=1 and return to determining 804 whether n=N. Alternatively, if the early-termination cascade classifier 218 determines that the combined classifier score is inconclusive, the early-termination cascade classifier 218 may proceed to examine a subsequent weak classifier. Thus, the early-termination cascade classifier 218 may set 816 m=m+1 and determine 820 whether m=M. If m=M, the evaluation of a stage is complete and the early-termination cascade classifier may output 806 a face or a non-face decision for the nth stage. In this case, the stage decision may be based on the combined classifier score for all of the weak classifiers within stage n. The early-termination cascade classifier 218 may then set 818 as n=n+1, m=1 and return to determining 804 whether n=N. If m is not equal to M, the method 800 may proceed to evaluating 808 an mth weak classifier using the new value for m.

The early-termination cascade classifier 218 may thus evaluate subsequent weak classifiers in each subsequent stage as described. It is noted that not every weak classifier is necessarily examined within each stage because a decision is made as to whether a combined weak classifier score exceeds a face threshold or a non-face threshold at each subsequent weak classifier. Thus, unlike the VJ framework, where a decision is made only after evaluation of all weak classifiers within a stage, the early-termination cascade classifier 218 may determine a face or non-face decision for a stage without necessarily examining every weak classifier. This early termination may result in less processing without sacrificing accuracy of face detection.

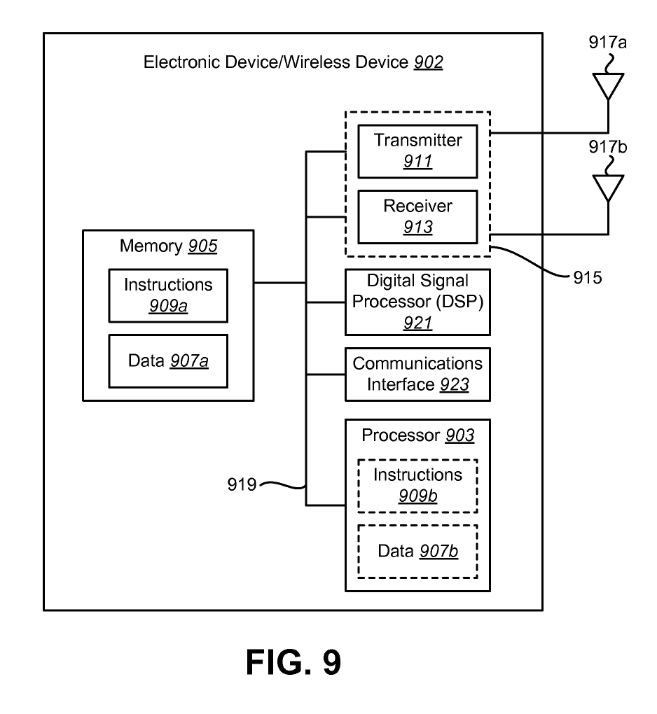

FIG. 9 illustrates certain components that may be included within an electronic device/wireless device 902. The electronic device/wireless device 902 may be an access terminal, a mobile station, a user equipment (UE), a base station, an access point, a broadcast transmitter, a node B, an evolved node B, etc., such as the electronic device 102 illustrated in FIG. 1. The electronic device/wireless device 902 includes a processor 903. The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the electronic device/wireless device, in an alternative configuration, a combination of processors (e.g., an ARM and DSP) could be used.

The electronic device/wireless device 902 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers, and so forth, including combinations thereof.

Data 907a and instructions 909a may be stored in the memory 905. The instructions 909a may be executable by the processor 905 to implement the methods disclosed herein. Executing the instructions 909a may involve the use of the data 907a that is stored in the memory 905. When the processor 903 executes the instructions 909a, various portions of the instructions 909b may be loaded onto the processor 903, and various pieces of data 907b may be loaded onto the processor 903.

The electronic device/wireless device 902 may also include a transmitter 911 and a receiver 913 to allow transmission and reception of signals to and from the electronic device/wireless device 902. The transmitter 911 and receiver 913 may be collectively referred to as a transceiver 915. Multiple antennas 917a-b may be electrically coupled to the transceiver 915. The electronic device/wireless device 902 may also include (not shown) multiple transmitters, multiple receivers, multiple transceivers and/or additional antennas.

The electronic device/wireless device 902 may include a digital signal processor (DSP) 921. The electronic device/wireless device 902 may also include a communications interface 923. The communications interface 923 may allow a user to interact with the electronic device/wireless device 902.

The various components of the electronic device/wireless device 902 may be coupled together by one or more buses 919, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

In accordance with the present disclosure, a circuit, in an electronic device, may be adapted to perform face detection by evaluating a scanning window using a first weak classifier in a first stage classifier. The same circuit, a different circuit, or a second section of the same or different circuit may be adapted to evaluate the scanning window using a second weak classifier in the first stage classifier based on the evaluation by the first weak classifier. The second section may advantageously be coupled to the first section, or it may be embodied in the same circuit as the first section. In addition, the same circuit, a different circuit, or a third section of the same or different circuit may be adapted to control the configuration of the circuit(s) or section(s) of circuit(s) that provide the functionality described above.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio and microwave, then the coaxial cable, fiber optic cable, twisted pair, DSL, or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 3, 4, 7 and 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method for face detection, comprising:
evaluating a scanning window using a first weak classifier in a first stage classifier; and
evaluating the scanning window using a second weak classifier in the first stage classifier based on the evaluation using the first weak classifier.

2. The method of claim 1, wherein evaluating the scanning window using the second weak classifier comprises performing early termination of the first stage classifier by outputting a face decision for the first stage classifier without evaluating the second weak classifier when the evaluation using the first weak classifier is face.

3. The method of claim 1, wherein evaluating the scanning window using the second weak classifier comprises performing early termination of the first stage classifier by outputting a non-face decision for the first stage classifier without evaluating the second weak classifier when the evaluation using the first weak classifier is non-face.

4. The method of claim 1, wherein evaluating the scanning window using the second weak classifier comprises evaluating the scanning window using the second weak classifier when the evaluation using the first weak classifier is inconclusive.

5. The method of claim 4, further comprising evaluating the scanning window using a third weak classifier in the first stage classifier based on the evaluation using the first weak classifier and the evaluation using the second weak classifier.

6. The method of claim 5, wherein evaluating the scanning window using the third weak classifier comprises:
performing early termination of the first stage classifier by outputting a face decision for the first stage classifier without evaluating the third weak classifier when a combination of the evaluation using the first weak classifier and the second weak classifier is face;
performing early termination of the first stage classifier by outputting a non-face decision for the first stage classifier without evaluating the third weak classifier when a combination of the evaluation using the first weak classifier and the second weak classifier is non-face; and
evaluating the scanning window using the third weak classifier when the evaluation using the first weak classifier and the second weak classifier is inconclusive.

7. An apparatus for face detection, comprising:
means for evaluating a scanning window using a first weak classifier in a first stage classifier; and
means for evaluating the scanning window using a second weak classifier in the first stage classifier based on the evaluation using the first weak classifier.

8. The apparatus of claim 7, wherein the means for evaluating the scanning window using the first weak classifier comprises means for traversing a node tree of weak classifier features, wherein a feature is evaluated at a first level of the node tree to determine a next node on a next level of the node tree to evaluate.

9. The apparatus of claim 8, wherein the weak classifier features are local binary pattern (LBP) features.

10. The apparatus of claim 9, wherein the LBP features are evaluated using a lookup table with the LBP features as indices.

11. The apparatus of claim 8, wherein each pixel in the scanning window is associated with a local binary pattern (LBP) that comprises eight bits, each indicating an intensity of the pixel relative to one of eight neighboring pixels.

12. The apparatus of claim 7, wherein the stage classifiers are evaluated using at least one ternary decision.

13. A computer-program product for face detection, comprising a non-transitory computer-readable medium having instructions thereon, the instructions comprising:
code for causing an electronic device to evaluate a scanning window using a first weak classifier in a first stage classifier; and
code for causing the electronic device to evaluate the scanning window using a second weak classifier in the first stage classifier based on the evaluation using the first weak classifier.

14. The computer-program product of claim 13, wherein the code for causing the electronic device to evaluate the scanning window using the first weak classifier comprises code for causing the electronic device to obtain a ternary decision of the first weak classifier.

15. The computer-program product of claim 14, wherein the code for causing the electronic device to evaluate the scanning window using the second weak classifier is based on the result of the ternary decision of the first weak classifier.

16. The computer-program product of claim 13, wherein the code for causing the electronic device to evaluate the scanning window using the second weak classifier comprises code for causing the electronic device to obtain a cumulative score of the first weak classifier and the second weak classifier.

17. The computer-program product of claim 16, wherein the cumulative score of the first weak classifier and the second weak classifier is compared to a cumulative face threshold value and a cumulative non-face threshold value for the first weak classifier and the second weak classifier.

18. The computer-program product of claim 17, wherein each weak classifier in the first stage classifier comprises a cumulative face threshold value and a cumulative non-face threshold value loaded from memory.

19. The computer-program product of claim 16, wherein the code for causing the electronic device to evaluate the scanning window using the second weak classifier comprises code for causing the electronic device to perform early termination of the first stage classifier if the cumulative score of the first weak classifier and the second weak classifier is face or non-face.

20. The computer-program product of claim 16, wherein the code for causing the electronic device to evaluate the scanning window using the second weak classifier comprises code for causing the electronic device to obtain a cumulative score of the first weak classifier, the second weak classifier, and a third weak classifier if the cumulative score of the first weak classifier and the second weak classifier is inconclusive.

21. An apparatus for face detection, comprising:
a processor;
memory in electronic communication with the processor;
instructions stored in memory, the instructions being executable to:
evaluate a scanning window using a first weak classifier in a first stage classifier; and
evaluate the scanning window using a second weak classifier in the first stage classifier based on the evaluation using the first weak classifier.

22. The apparatus of claim 21, wherein the instructions are further executable to:
select the scanning window using a first step size;
receive a first confidence value indicating a likelihood that the scanning window comprises at least a portion of a face; and
determine a second step size based on the first confidence value.

23. The apparatus of claim 22, wherein the first confidence value is based on evaluating the scanning window using a first weak classifier.

24. The apparatus of claim 22, wherein the first step size and the second step size each comprise a number of pixels to skip in an x direction, a number of pixels to skip in a y direction or both.

25. The apparatus of claim 22, wherein the instructions are further executable to:
select a second scanning window based on the second step size; and
determine whether the second scanning window comprises at least a portion of a face.

26. The apparatus of claim 22, wherein the second step size is further based on the first step size.

27. The apparatus of claim 22, wherein the instructions executable to determine the second step size comprises instructions executable to:
assign one or more first values to the second step size when the first confidence value indicates that the first scanning window likely comprises at least a portion of a face; and
assign one or more second values to the second step size when the first confidence value indicates that the first scanning window likely does not comprise at least a portion of a face, wherein the first values are less than the second values.

28. The apparatus of claim 27, wherein the instructions being executable to evaluate a scanning window using the second weak classifier comprise instructions being executable to perform early termination of the first weak classifier by outputting a face decision for the first stage classifier without evaluating the second weak classifier when the evaluation using the first weak classifier is face.

29. The apparatus of claim 27, wherein the instructions being executable to evaluate a scanning window using the second weak classifier comprise instructions being executable to perform early termination of the first weak classifier by outputting a non-face decision for the first stage classifier without evaluating the second weak classifier when the evaluation using the first weak classifier is non-face.

30. The apparatus of claim 27, wherein the instructions being executable to evaluate a scanning window using the second weak classifier comprise instructions being executable to evaluate the scanning window using the second weak classifier when the evaluation using the first weak classifier is inconclusive.
